(19) United States
(12) Patent Application Publication
(10) Pub. No.: US 2012/0183102 A1
(43) Pub. Date: Jul. 19, 2012

(54) Receiver Circuits and Systems for Receiving Medium Wave and Short Wave Signals

(75) Inventors: Scott Willingham, Austin, TX (US); Vivek Sarda, Austin, TX (US)

(73) Assignee: SILICON LABORATORIES, INC., Austin, TX (US)

(21) Appl. No.: 13/007,572

(22) Filed: Jan. 14, 2011

(51) Int. Cl. H04B 1/16; H04L 27/06

(52) U.S. Cl. 375/340; 455/227

(57) ABSTRACT

A receiver includes a first terminal for receiving an RF signal having a frequency of less than approximately 60 MHz, a second terminal, and a receive path having an input coupled to the first terminal and an output for providing a demodulated RF signal. The receiver further includes a detector coupled to the receive path for detecting a signal parameter in the RF signal and a controller coupled to the detector and to the second terminal. The controller provides the multiplex signal in a tuning state to the second terminal to selectively provide one of a first RF signal and a second RF signal to the first terminal and to determine at least one of a first parameter of the first RF signal and a second parameter of the second RF signal. The controller provides the multiplex signal in an operating state based on the first parameter and the second parameter.

### FIELD

The present disclosure is generally related to receiver circuits, and more particularly to receiver circuits and systems for receiving medium wave and short wave radio signals.

### BACKGROUND

Radio frequency circuits can be configured to receive frequency modulated (FM) signals, amplitude modulated (AM) signals and/or a multitude of digital modulation schemes. Conventional portable receiver devices typically include compact antennas, which are typically proportional to wavelengths of signals in the high frequency bands, but which are a very small fraction of the wavelengths of signals in the medium wave and short wave frequency bands.

Whip antennas are often used to receive radio signals for AM/FM radios. For example, vehicles use electrically-short whip antennas for reception of medium-wave radio signal; however, such antennas work best with a large ground, such as the vehicle body. Further, a whip antenna introduces a large impedance, making it difficult to construct a tuned front-end circuit without losing signal to capacitive division. Additionally, whip antennas are sensitive to near field electrical interference, contact, and nearby objects.

Many portable AM receivers include ferrite loop antennas (sometimes referred to as “loop sticks”). Larger radios sometimes use larger-diameter, flat, air coils, which is another type of “loop” antenna. Loop antennas, such as loop sticks and air coils, are inherently directional, causing the user to experience signal nulls if the radio is rotated.

### SUMMARY

In an embodiment, a receiver circuit includes a first terminal for receiving a radio frequency (RF) input signal having a frequency of less than approximately 60 MHz, a second terminal for providing a multiplex signal, and a receive path having an input coupled to the first terminal, and an output for providing a demodulated RF signal corresponding to the radio signal. The receiver circuit further includes a detector coupled to the receive path for detecting a signal parameter in the RF input signal that corresponds to the radio signal and includes a controller coupled to the detector and to the second terminal. The controller provides the multiplex signal in a tuning state to selectively provide one of a first RF signal from a first directional antenna and a second RF signal from a second directional antenna to the first terminal as the RF input signal and to determine at least one of a first signal parameter of the first RF signal and a second signal parameter of the second RF signal in response to providing the multiplex signal. The receiver circuit further provides the multiplex signal in an operating state based on the first signal parameter and the second signal parameter.

In another embodiment, a radio receiver includes a receive path having an input terminal for receiving a low-frequency radio frequency (RF) signal including at least one of a first RF signal and a second RF signal, and having an output for providing a demodulated RF signal. The low-frequency RF signal has a frequency of less than approximately 60 MHz. The radio receiver further includes a detector coupled to the receive path for detecting a signal parameter in the low-frequency RF signal that corresponds to at least one of the first and second RF signals and a controller configured to dynamically select between the first RF signal and the second RF signal in response to detecting the signal parameter.

In yet another embodiment, a radio receiver includes a casing defining an enclosure, a first directional antenna within the enclosure having a first signal reception pattern, and a second directional antenna within the enclosure and having second signal reception pattern that substantially complements the first signal reception pattern. The radio receiver further includes a connector coupled to the first and second directional antennas and adapted to deliver radio frequency signals to an input of a portable electronic device.

In still another embodiment, a system includes an antenna assembly for receiving a radio frequency (RF) signal, including at least one of a short wave signal and a medium wave signal, having audio or data content at frequencies below approximately 60 MHz. The antenna assembly includes a first directional antenna having a first signal reception pattern, a second directional antenna defining a second signal reception pattern that is substantially complementary relative to the first signal reception pattern, and a connector coupled to the first directional antenna and the second directional antenna. The system further includes a radio receiver having an input port adapted to couple to the connector and a receive path including an input terminal coupled to the input port and adapted to receive the RF signal from at least one of the first directional antenna and the second directional antenna, and an output terminal for providing a demodulated RF signal. The radio receiver further includes a detector coupled to the receive path for detecting a signal parameter in the RF input signal that corresponds to the AM signal and a controller configured to dynamically select between the first directional antenna and the second directional antenna in response to detecting the signal parameter.

### BRIEF DESCRIPTION OF THE DRAWINGS

FIG. 1 is a diagram depicting an example of a first receiver system with an air-core loop antenna and an example of a second receiver system with a ferrite loop stick antenna.

FIG. 2 is a polar diagram of signal reception strength versus direction for the air-core loop antenna of FIG. 1.

FIG. 3 is a block diagram of a receiver system including a radio receiver and an external accessory including multiple medium wave antennas arranged to provide substantially complementary signal reception strength patterns.

FIG. 4 is a polar diagram of signal reception strength versus direction for the receiver system of FIG. 3.

FIG. 5 is a polar diagram of signal reception strength versus direction for the radio receiver of FIG. 3 illustrating the algebraic combination of the received signals from the multiple medium wave antennas.

FIG. 6 is a block diagram of a system including a receiver circuit configured to receive medium wave radio signals from multiple directional antennas.

FIG. 7 is a partial circuit diagram and partial block diagram of a portion of the system of FIG. 6.

FIG. 8 is a block diagram of a system including components of a radio receiver having a DSP and a memory accessible to the DSP that is configured to implement directional diversity.

FIG. 9 is a circuit schematic of one possible embodiment of a switching circuit configured to switch between directional antennas.

FIG. 10 is a diagram of an embodiment of an external accessory having multiple directional antennas with substantially complementary reception patterns.

FIG. 11 is a diagram of a system including a cell phone coupled to the external accessory of FIG. 10.

In the following description, the use of the same reference numerals in different drawings indicates similar or identical items.

### DETAILED DESCRIPTION OF ILLUSTRATIVE EMBODIMENTS

Broadcast radio coverage in rural areas is sometimes limited, in part, because the frequency modulation (FM) radio signals preferred for portable communication attenuate significantly over long distances. Medium-wave (typically as amplitude modulated (AM) signals) can travel further, making AM broadcast receivers desired features for portable radios, media devices, and cell phones marketed in rural areas where long distance AM coverage is superior to FM coverage. AM frequencies are about one hundred times lower than FM frequencies, making their wavelengths significantly longer and making the compact antennas within such portable receivers less efficient for receiving the AM signals. In addition, practical compact antennas (such as ferrite loop stick antennas) are inherently directional, so mobile devices that use AM signals tend to cut in and out. Further, cell phones, and particularly their display-related electronics, produce substantial interference within the AM frequency bands, further complicating AM reception. In some instances, it may also be desirable to receive short wave radio frequency signals using the same device.

Embodiments of an antenna assembly are described below that provide multiple directional antennas arranged to have substantially complementary signal reception patterns to provide enhanced short wave (SW) and medium wave (MW) signal reception for portable electronic devices, such as cell phones, portable radios, and the like. The antenna assembly can be implemented as an external accessory, such as an external antenna device that might be clipped to a user's clothing and coupled to an electronic device, such as a cell phone, to provide the enhanced SW and MW signal reception.

Further, embodiments of a radio receiver include a receive path having an input terminal for receiving a radio frequency (RF) signal including at least one of a first RF signal and a second RF signal, and having an output for providing a demodulated RF signal. The radio receiver includes a detector coupled to the receive path for detecting a signal parameter in the RF input signal that corresponds to one of the first and second RF signals and includes a controller configured to dynamically select between the first RF signal and the second RF signal in response to detecting the signal parameter. The signal parameter includes at least one of a signal strength, a signal power, and a signal-to-noise ratio. In some instances, the radio receiver dynamically switches between signals from the antennas and/or algebraically combines the signals from the antennas. The radio receiver includes a processor configured to execute instructions that, when executed, cause processor to adaptively adjust signal reception based on signal strength, signal-to-noise ratio, signal power levels, or other signal parameters.

Embodiments of a system include a multiplexer responsive to a controller of the radio receiver for selecting between a first directional antenna and a second directional antenna to control the RF input signal. In one embodiment, the multiplexer is within an external antenna assembly. In another embodiment, the multiplexer is within an integrated circuit including the radio receiver. In still another embodiment, the multiplexer is located within a housing of a portable electronic device that includes an integrated circuit having the radio receiver and is external to the integrated circuit.

FIG. 1 is a diagram depicting two representative examples of receiver systems 100 and 110 including different types of loop antennas. Receiver system 100 includes an AM radio receiver 102 connected to an air-core loop antenna 104 tuned for the medium-wave RF signals (such as the AM radio band) and/or short-wave RF signals. The following discussion addresses AM signals, but it should be understood that the discussion applies to short-wave and medium-wave signals (of which the AM signal is a representative example). Air-core loop antenna 104 includes multiple turns or coils of conductive material, such as copper wire, configured to form a loop shape, such as a square, octagonal, or circular forms. Because of the extremely long wavelength of AM signals, air-core loop antenna 104 can have multiple turns of wire and still have a length of less than 1/10 of a wavelength. Air-core loop antenna 104 is passive (non-amplified), and is tuned within the AM band using a variable tuning capacitor within AM radio receiver 102.

Receiver system 110 includes an AM radio receiver 112 connected to a loop stick antenna 114, which is implemented as multiple turns or coils of conductive material wrapped around a ferrite stick, increases the gain of the conductive wire, thereby increasing the sensitivity. While loop stick antenna 114 is depicted as being external to AM radio receiver 112, loop stick antenna 114 is a type of antenna that is often used as an internal antenna in portable radios that receive AM band signals.

Air-core antenna loop 104 and loop stick antenna 114 react to the magnetic portion of the received RF energy and are relatively immune to the electrical component of the RF energy, which can be effected by noise from electrical sources. Air-core loop antenna 104 and loop stick antenna 114 are directional antennas, meaning that their respective orientations determine their signal reception pattern. In particular, air-core loop antenna 104 and loop stick antenna 114 are directional along the axis of highest gain, and have a sharp null in the axis perpendicular to their highest gain. For ease of discussion, an axis 116 is shown having an orientation 118 where the X-axis extends horizontally in the plane of the page, the Y-axis extends vertically in the plane of the page, and the Z-axis extends perpendicular to the X and Y axes and extends out from and perpendicular to the page. Corresponding negative components of axis 116 are not shown.

Air-core loop antenna 104 has its axis of highest gain along the circumferential edges of the coils (i.e., for signals directed toward the coils (sides) of the air-core loop antenna 104 in X-Y plane indicated by axis 116) and has a null with respect to signals directed substantially perpendicular to the center of the coil (i.e., for signals directed to the center of the loop in the Z-direction indicated by axis 116). Loop stick antenna 114 has its axis of highest gain along the circumferential edges of the coils (i.e., for signals directed toward the loop stick antenna 114 in the Y-Z-plane indicated by axis 116) and has its null with respect to signals directed in the X-direction.

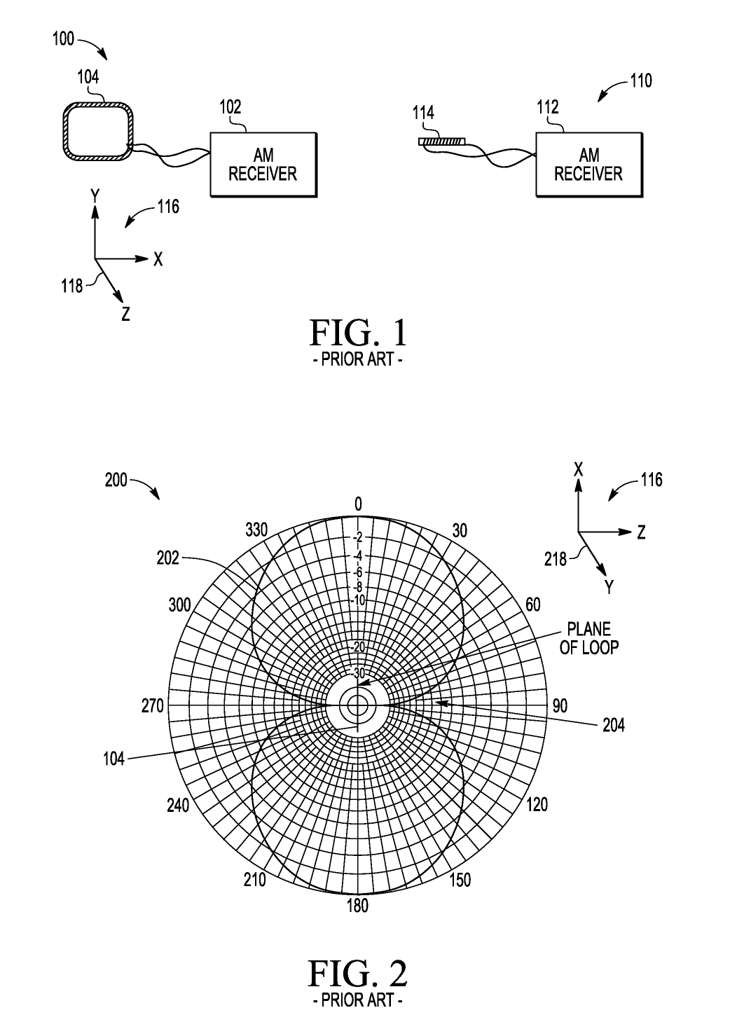

In general, air-core loop antenna 104 and loop stick antenna 114 have directional signal reception patterns. The directional signal reception patterns are symmetric about the plane of the coils. An example of the directional signal reception pattern for the air-core loop antenna 104 is described below with respect to FIG. 2.

FIG. 2 is a two-dimensional polar diagram 200 of signal reception strength versus direction for the air-core loop antenna 104 of FIG. 1, depicting the signal reception pattern in the X-Z plane of axis 116. Polar diagram 200 depicts a circle with divided into five degree increments and defining a 360-degree plot with loop antenna 104 at the center. The axis 116 has an orientation 218 that is rotated relative to the orientation 118 in FIG. 1. The orientation 218 of axis 116 includes the X-axis extending vertically within the plane of the page, the Y-axis extending perpendicular to the X-axis and perpendicular to the plane of the page, and the Z-axis extends horizontally within the plane of the page.

Polar diagram 200 depicts a signal reception pattern 202 having its highest gain along the X-axis in the positive X and negative X directions. A similar, high-gain signal reception pattern 202 would extend along the Y-axis. Air-core loop antenna 104 has reception strength nulls along its Z-axis. While polar diagram 200 depicts the signal reception pattern 202 for the air-core antenna oriented in the X-Y plane of axis 116, loop stick antenna 114 produces a similar reception pattern if rotated 90 degrees such that it extends longitudinally along the Z-axis.

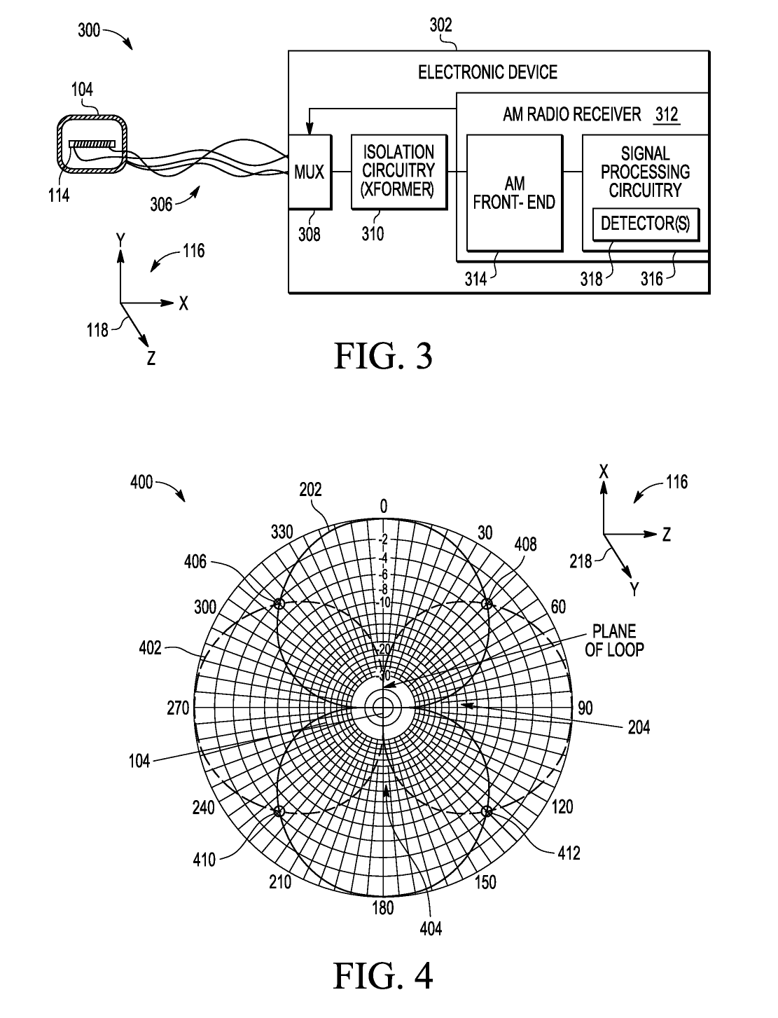

When using such directional antennas in portable devices, such as cell phones, the directionality of the antenna can cause the received signal to cut in and out. It is possible to combine the air-core loop antenna 104 with the loop stick antenna 114 to enhance signal reception. An example of one possible implementation of such a multi-loop antenna and associated electronic device are described below with respect to FIG. 3.

FIG. 3 is a block diagram of a receiver system 300 including an electronic device 302 and an external accessory 304 including multiple medium wave antennas arranged to provide substantially complementary signal reception strength patterns. External accessory 304 includes air-core loop antenna 104 and loop stick antenna 114 arranged in the X-Y plane of axis 116 having orientation 118. In this example, loop stick antenna 114 extends along the X-axis, and the coils of air-core loop antenna are formed in the X-Y plane. Air-core loop antenna 104 provides a first reception pattern, and loop stick antenna 114 provides a second reception pattern that substantially complements the first reception pattern.

Air-core loop antenna 104 and loop stick antenna 114 are connected to electronic device through wires 306. Electronic device 302 includes a multiplexer 308 including multiple inputs connected to wires 306, a control input, and at least one output connected to electrical isolation circuit 310, such as a transformer. Electronic device 302 further includes an AM radio receiver 312 including an AM front-end circuit 314 connected to the electrical isolation circuit 310 and including signal processing circuit 316 connected to the AM front-end circuit 314. AM front-end circuit 314 defines a receive signal path having an input coupled to the first terminal, and an output for providing a demodulated RF signal corresponding to the AM radio signal to signal processing circuit 316. Signal processing circuit 316 may include one or more general purpose processors, a digital signal processor, or any combination thereof.

In an example, AM front-end circuit 314 includes a low-noise amplifier, a mixer to mix received signals to an intermediate frequency (IF), one or more filters, one or more amplifiers, and one or more analog-to-digital converters. AM front-end circuit 314 receives selected signals from at least one of air-core loop antenna 104 and loop stick antenna 114 and provides a digital representation of the selected signals to signal processing circuit 316. Signal processing circuit 316 includes at least one digital signal processor configured to execute processor-readable instructions stored in a memory (not shown) for processing the signals. Signal processing circuit 316 includes one or more detectors 318 configured to determine signal parameters associated with the selected signals, such as signal strength, signal-to-noise ratio, other signal parameters, or any combination thereof.

In one embodiment, signal processing circuitry 316 controls multiplexer 308, in response to determining the signal parameters, to select one of a first AM signal received by air-core loop antenna 104 and a second AM signal received by loop stick antenna 114. Once one of the antennas is selected, signal processing circuitry 316 controls multiplexer 308 to provide the selected one of the first and second AM signals to isolation circuitry 310.

One or more detectors 318 monitor the signal parameters, and signal processing circuitry 316 selectively switches multiplexer 308 in response to detecting that the signal parameter has fallen below a corresponding threshold. In an example, if the signal strength of the signal from air-core loop antenna 104 decreases by more than a pre-determined threshold, the power level of the signal falls below a power threshold, and/or the signal-to-noise ratio (SNR) decreases by an SNR threshold amount, in response to detecting these conditions, AM radio receiver 312 provides a control signal (selection signal) to control multiplexer 308 to select loop stick antenna 114, providing signals from loop stick antenna 114 to electrical isolation circuit 310. If the signals from loop stick antenna 114 are not better than those from air-core loop antenna 104, AM radio receiver 312 may control multiplexer 308 to switch back.

In an embodiment, AM front-end 314 provides multiple signal paths. In this instance, signals from both antennas follow separate signal paths within AM front-end circuit 314, which provides intermediate frequency (IF) signals from the signal paths to signal processing circuitry 316. Signal processing circuit 316 is configured to select between the IF signals based on the signal parameters and/or to combine them algebraically (sum or difference) to produce an enhanced signal pattern, which preferably has improved parameters (e.g., signal strength, signal power, or SNR relative to either of the demodulated RF signals alone).

Receiver system 300 takes advantage of the directionality of the air-core loop antenna 104 and the loop stick antenna 114 of external accessory 304 to provide complementary signal reception patterns. One example of the complementary signal reception patterns is described below with respect to FIG. 4.

FIG. 4 is a two-dimensional polar diagram 400 of signal reception strength versus direction for air-core loop antenna 104 and loop stick antenna 114 of the accessory 304 of FIG. 3. Air-core loop antenna 104 and loop stick antenna 114 are coplanar in the X-Y plane of axis 116. Air-core loop antenna 104 has a signal reception pattern 202 having a highest gain along the X-axis and with nulls 204 along the Z-axis. Loop stick antenna 114 produces a signal reception pattern 402 that is substantially complementary to signal reception pattern 202, having a highest gain along the Z-axis and nulls 404 along the X-axis.

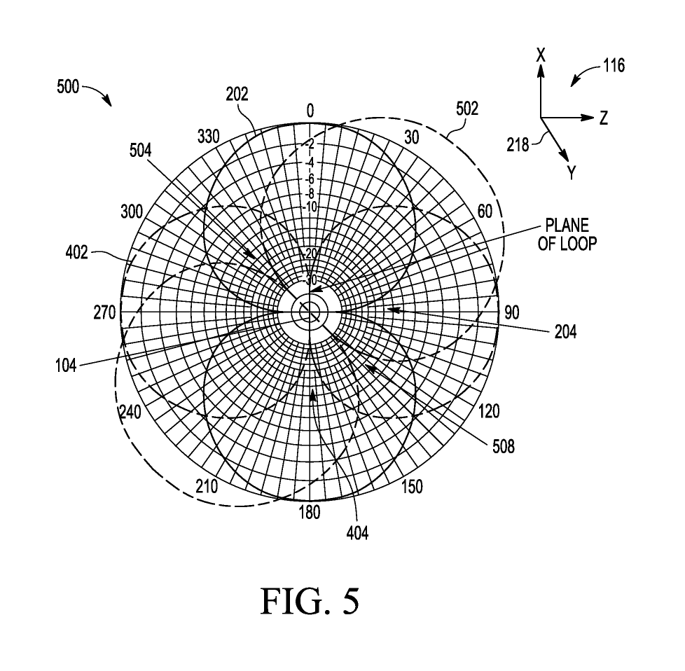

In the illustrated example, air-core loop antenna 104 and loop stick antenna 114 are coplanar and configured to provide signal receptions patterns 202 and 402 that are substantially orthogonal to one another. While the complementary signal reception patterns 202 and 402 appear to provide acceptable reception coverage, the signal reception patterns 202 and 402 are algebraically combined (sum or difference). If the polarity is such that intersection points 408 and 410 add constructively, then intersection points 406 and 412 cancel each other. An example of the resulting signal reception pattern is described below with respect to FIG. 5.

FIG. 5 is a two-dimensional polar diagram 500 of the signal reception patterns 202 and 402 from air-core loop antenna 104 and loop stick antenna 114 and their algebraic combination for the receiver system of FIG. 3. The sum of the signal reception patterns 202 and 402 produces a third signal pattern 502, having its highest gains at angles of approximately 45 degrees and 225 degrees and having nulls 504 at angles of approximately 315 degrees and 135 degrees.

Inverting the phase of one of the signals received by either the air-core loop antenna 104 or the loop stick antenna produces a signal reception pattern that is rotated by 90 degrees. Thus, the combination of the signal reception patterns 202 and 402 produces the third signal pattern 502 that is also directional, with the widths of the nulls 504 from the minus 10 dB point relative to the maximum signal strength being nearly the same as the widths of the nulls 204 and 404.

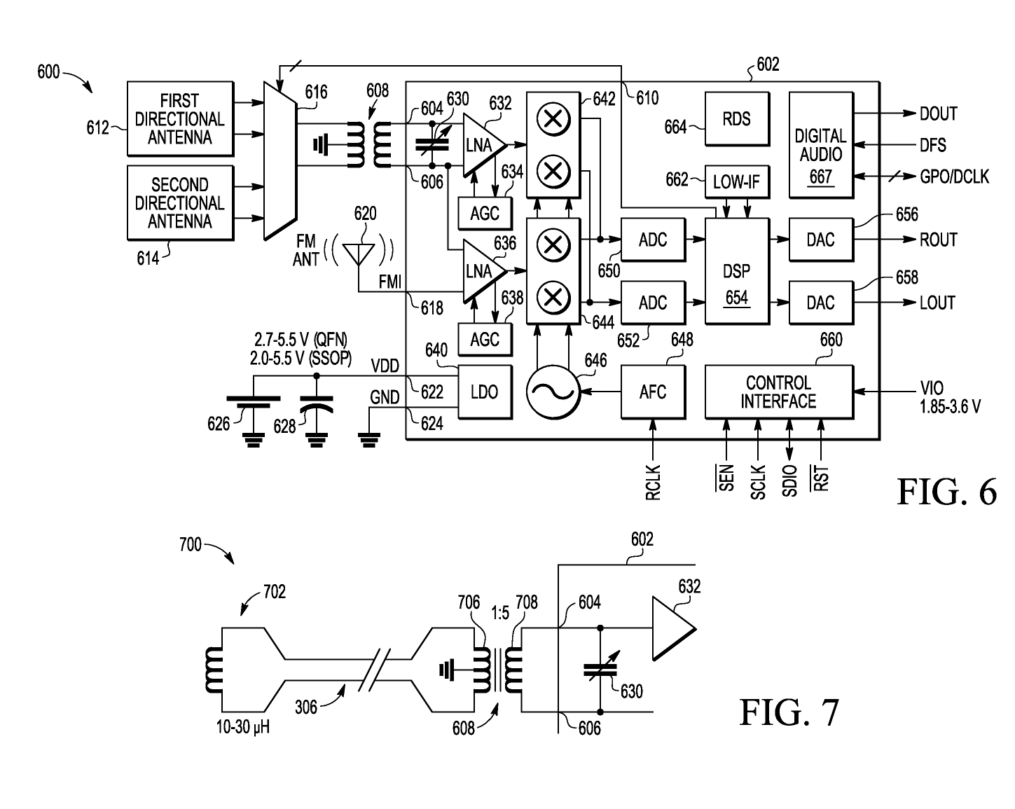

Thus, using two directional antennas (air-core loop antenna 104 and loop stick antenna 114) with complementary signal reception patterns 202 and 402 provides an opportunity for improved signal reception for a portable device. In particular, as described below with respect to FIG. 6, a circuit is configured to selectively combine (sum or difference) the reception signal patterns and/or to dynamically switch between the directional antennas to provide directional diversity, selecting an appropriate active antenna pattern for the reception of the radio frequency signal.

FIG. 6 is a block diagram of a system 600 including a radio receiver circuit 602 configured to receive medium wave AM radio signals from multiple directional antennas. Radio receiver circuit 602 includes antenna inputs 604 and 606 connected to a secondary winding of a transformer 608, which includes a primary winding connected to a multiplexer 616. Multiplexer 616 includes multiple radio frequency signal inputs connected to a first directional antenna 612 and a second directional antenna 614 for receiving radio frequency signals, such as AM signals. Radio receiver circuit 602 provides AM band reception within a frequency range from approximately 520 kHz to approximately 1710 kHz. The first directional antenna 612 and the second directional antenna 614 may be air-core loop antennas (such as air-core loop antenna 104), loop stick antennas (such as loop stick antenna 114), or any combination thereof. First directional antenna 612 and second directional antenna 614 are arranged to provide substantially complementary signal reception patterns. Multiplexer 616 further includes a control input connected to a control output 610 of radio receiver circuit 602. In some instances, multiplexer 616 includes multiple control inputs connected to multiple outputs of radio receiver circuit 602.

Radio receiver circuit 602 further includes a frequency modulated (FM) radio signal input 618 connected to an FM antenna 620. Additionally, radio receiver circuit 602 includes a low drop-out regulator 640 connected to ground through a ground pin 624 and connected to a power source 626 through a power supply pin (VDD) 622. Power supply pin (VDD) 622 is also connected to a first electrode of a capacitor having a second electrode connected to ground.

Radio receiver circuit 602 includes a varactor (or variable capacitance diode) 630 having a first terminal connected to antenna input 604 and a second terminal connected to antenna input 606. Radio receiver circuit 602 further includes a low-noise amplifier (LNA) 632 including a first input connected to antenna input 604, a second input connected to antenna input 606, a gain control input and gain control output connected to adjustable gain control 634, and an output connected to mixer 642. Radio receiver circuit 602 further includes LNA 636 having a first input connected to the antenna input 606, a second input connected to FM radio signal input 618, a gain control input and gain control output connected to adjustable gain control 638, and an output connected to mixer 644.

Radio receiver circuit 602 includes local oscillator 646 including an input connected an adjustable frequency control circuit 648 configured to receive a programmable reference clock signal (RCLK) from an RCLK input, which may be connected to a host system. Local oscillator 646 is responsive to the adjustable frequency control circuit 648 to provide a clock signal to mixers 642 and 644, for mixing received radio frequency signals to in-phase and quadrature (I and Q) intermediate frequency (IF) signals. Mixers 642 and 644 provide the in-phase signals to ADC 650 and the quadrature signals to ADC 652, which digitize the signals to produce digital signals and provide the digital signals to digital signal processor (DSP) 654. DSP 654 receives low IF signals from LOW IF circuit 662 and processes the digital signals according to instructions stored in a memory (not shown). Further, DSP 654 is configured to perform AM radio signal demodulation. DSP 654 is connected to digital-to-analog converters 656 and 658 to provide right and left output signals, respectively. Further, DSP 654 is connected to control output 610 to control multiplexer 616. Further, DSP 654 may be connected to digital audio circuit 667, which allows radio receiver circuit 602 to function in a digital audio mode. When in digital audio mode, digital audio circuit 667 uses a digital frame synchronization (DFS) input and uses a general purpose output (GPO)/digital clock input (DCLK), and provides a digital output to a digital output pin (DOUT).

Radio receiver circuit 602 further includes incorporates a digital processor for the European Radio Data System (RDS) and the North American Radio Broadcast Data System (RBDS) (collectively the “RDS circuit 664”). RDS circuit 664 provides symbol decoding, block synchronization, error detection, and error correction functions.

Additionally, radio receiver circuit 602 includes a control interface 660, which is connected to an input/output voltage supply pin (VIO) for receiving a voltage supply. Additionally, control interface 660 is connected to an active low serial enable input (SEN) pin, a serial clock input (SCLK) pin, a serial data input/output (SDIO), and an active low device reset (RST) pin. Control interface 660 is configurable to connect to a host system (not shown) for receiving serial data, including instructions for execution by DSP 654, configuration settings, and other data and for sending information to the host system. In one example, the host system configures DSP 654 to select between first directional antenna 612 and second directional antenna 614 to provide directional diversity.

In an example, varactor 630, LNA 632, mixer 642 and ADCs 650 and 652 provide a signal path from input terminals 604 and 606 to DSP 654. DSP 654 operates both to process the AM radio signal and as a controller to selectively control multiplexer 616 to provide RF signals from one of the first directional antenna 612 and the second directional antenna 614 to receiver circuit 602 through transformer 608.

In an example, when radio receiver circuit 602 is switched to an AM radio receive mode, DSP 654 controls multiplexer 616 to select first directional antenna 612 and compares at least one of a signal strength, a SNR parameter, and another signal parameter of the received signal to a corresponding threshold (i.e., a signal strength threshold, an SNR threshold, or another threshold, respectively). If the parameter of the received signal exceeds the corresponding threshold, DSP 654 continues to receive the AM signals from first directional antenna 612. Otherwise, if the parameter of the received signal falls below or is below the corresponding threshold, DSP 654 controls multiplexer 616 to select received signals from the second directional antenna 614. If the parameter of the received signal from the second directional antenna 614 exceeds the threshold, DSP 654 continues to receive the signal from the second directional antenna 614. In this example, once one of the first directional antenna 612 and the second directional antenna 614 is selected by DSP 654, the signals from the selected one of the antennas provides radio signals to radio receiver circuit 602 until a parameter of the radio signals falls below a corresponding threshold. Thus, DSP 654 utilizes multiplexer 616 to select between the first directional antenna 612 and the second directional antenna 614 to provide directional diversity.

In an alternative embodiment, the first directional antenna 612 and the second directional antenna 614 may be separately connected to radio receiver circuit 602 through corresponding transformers. In this alternative embodiment, DSP 654 may be configured to control a multiplexer (not shown) to select between first signals from first directional antenna 612 and second signals from second directional antenna 614 to provide directional diversity and/or selectively combine (sum or difference) the first and second signals from the first and second directional antennas 612 and 614 to produce a combined signal having a signal pattern, such as signal pattern 502 in FIG. 5, for example.

Radio receiver circuit 602 uses the low IF architecture provided by mixers 642 and 644 in conjunction with local oscillator 646 and provided by low-IF circuit 662 to provide high-precision filtering for selectivity and SNR with minimum variation across the AM band. The DSP 654 also provides adjustable channel step sizes in 1 kHz increments, AM demodulation, soft mute, seven different channel bandwidth filters, and additional features, such as a programmable automatic volume control (AVC) maximum gain allowing users to adjust the level of background noise. LNA 632 and AGC 634 provide receive-signal sensitivity and rejection of strong interferers allowing for enhanced reception of weak stations.

In a particular embodiment, transformer 608 uses a 1:5 turn ratio inductor, which operates to increase the inductance by 25 times, providing support for air-core loop antennas, such as air-core loop antenna 104. Further, radio receiver circuit 602 is configured to support a wide range of ferrite loop sticks, such as loop stick antenna 114, having inductances ranging from approximately 180 μH to approximately 450 μH.

Unlike FM diversity, a change in the signal amplitude of an AM signal affects the demodulated audio signal. To implement a directional diversity scheme utilizing receiver circuit 602 and multiplexer 616 to select between multiple directional antennas, DSP 654 uses a fast switch-and-try technique with blanked audio. In particular, when a signal parameter falls below a corresponding threshold, DSP 654 briefly blanks the audio signal, switches antennas (such as from first directional antenna 612 to second directional antenna 614) and checks the signal parameter. DSP 654 provides the audio signal from the selected antenna if the signal parameter exceeds the threshold or is better than that of the other antenna. The blanking interval is suitably short so as to allow DSP 654 adequate time to detect the signal parameter without noticeably disrupting the user's listening experience.

In a particular embodiment, radio receiver circuit 602 is configured to support resonance tuning of the first and second directional antennas. In one instance, radio receiver circuit 602 tunes the AGC 634 and LNA 632 on startup, when switching between bands (such as from an FM receiving mode to an AM receiving mode), or when changing frequencies and/or stations and subsequently uses the tuned configuration to process received radio signals from first and second directional antennas 612 and 614. While radio receiver circuit 602 utilizes DSP 654 to control multiplexer 616, in an alternative embodiment, radio receiver 602 may utilize a microcontroller, a general purpose processor, logic circuitry, or a combination thereof to control multiplexer 616.

In the illustrated example, radio receiver circuit 602 uses an automatically tuned inductor/capacitor (LC) tank circuit represented by inductor 608 and varactor 630. Directional antennas 612 and 614 are inductive, and transformer 608 has a one-to-five ratio of turns and is configured to transform the inductance of the selected one of directional antennas 612 and 614 to an inductance compatible with the range of varactor 630. Further, varactor 630 is tuned to resonance in conjunction with the inductive antennas. In particular, tuning the LC tank to provide a high Q enhances the voltage gain of the received signal and suppresses off-channel signals. An imbalanced transformer configuration (without a center-tapped ground connection) can work well with a nearby directional loop antenna having short leads. However, an unbalanced circuit with high impedance produces a parasitic whip effect when long interconnect wires are used. Accordingly, an example of the balanced transformer configuration is shown and is further described below with respect to FIG. 7.

FIG. 7 is a partial circuit diagram and partial block diagram of an embodiment of a portion of a system 700 having a balanced transformer configuration for coupling at least one of the directional antennas (e.g., first directional antenna 612 and second directional antenna 614) to the radio receiver circuit 602 of FIG. 6. System 700 includes an inductive coil 702, representing one of an air-core loop antenna 104 or a loop stick antenna 114, connected to a primary winding 706 of transformer 608 by interconnect wires 306. Transformer 608 includes a secondary winding 708 connected to antenna inputs 604 and 606 of radio receiver circuit 602. Secondary winding 708 includes a first terminal connected to antenna input 604 and a second terminal connected to antenna input 606. Radio receiver circuit 602 includes varactor 630 having a first electrode connected to antenna input 604 and a second electrode connected to antenna input 606. Further, radio receiver circuit 602 includes LNA 632 having an input connected to antenna input 604.

Primary winding 706 has a center tap connected to ground, providing a balanced transformer coupling that cancels the common-mode signal on interconnect wires 306. In this instance, radio receiver circuit 602 receives a signal related to a magnetic flux through the inductive coil 702 that is remote from noise generated by an electronic device that includes radio receiver circuit 602. For example, if radio receiver circuit 602 is included within a cell phone, radio receiver circuit 602 receives a signal related to the magnetic flux through the inductive coil 702 remote from cell phone handset noise. A low impedance antenna enhances rejection of common mode signals and of “touch” disturbances, which may cause noise that might otherwise be received as radio signals. Air-core loop antenna 104 has an inductance that is smaller than approximately 10 μH to approximately 30 μH, making the air-core loop antenna 104 a practical option.

In a particular embodiment, transformer 608 is implemented as a toroid core transformer having a half-inch outer diameter formed from an Amidon Type-61 material. In this example, the primary winding 706 includes eight turns of a bifilar coil connected as equivalent to a 16 turn center-tapped winding. The secondary winding 708 includes eighty turns of wire. When the inductive coil 702 is disconnected from transformer 608, the self-inductance of secondary winding 708 is between approximately 400 μH and 450 μH. This 5:1 transformer winding turn ratio increases a sixteen micro-Henry (μH) antenna inductance twenty-five times to an inductance of approximately 400 μH. This reflected inductance, in parallel with the 400 μH self-inductance, is seen by radio receiver circuit 602. Varactor 630 operates to resonate against the effective 200 μH inductance of the transformer 608.

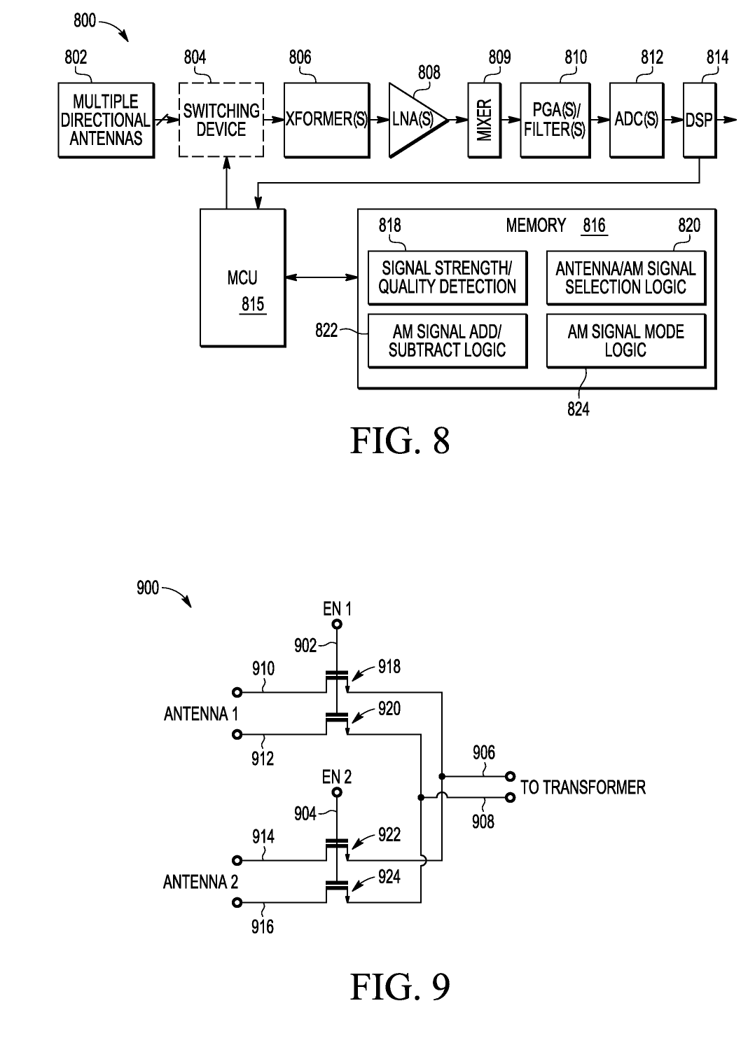

While the above-example depicts a block diagram of a radio receiver circuit 602, the programmability of DSP 654 is not represented. An example of a receiver system including functional blocks associated with a receiver circuit, such as radio receiver circuit 602 in FIG. 6, is described below with respect to FIG. 8, which includes a DSP and a memory accessible to the DSP that is configured to store firmware.

FIG. 8 is a block diagram of a system 800 including components of a radio receiver having a DSP 814 and a memory 816 accessible to the DSP 814. System 800 includes multiple directional antennas 802 connected to inputs of a switching device 804. Switching device 804 can be included within an external accessory, such as external accessory 304, together with multiple directional antennas 802. Alternatively, switching device 804 can be included within a main receiver housing along with a transformer 806.

Switching device 804 includes an output connected to a primary winding of a transformer 806. Transformer 806 has a secondary winding connected to an input of LNA 808. In some applications with built-in antennas, such as a portable radio, a “boom box,” a table-top radio, and the like, transformer 806 could be optional. LNA 808 includes an output connected to an input of a mixer 809, which has an output connected to a programmable gain amplifier (PGA)/filter 810. PGA/filter 810 includes an output connected to an input of ADC 812, which has an output connected to DSP 814. System 800 further includes a microcontroller (MCU) 815, which is coupled to DSP 814, which has access to instructions stored in memory 816, and which has an output for providing processed data to associated circuitry (such as switching device 804).

In an example, LNA 808, mixer 809, filter 810, and ADC 812 form a signal path from the transformer 806 to DSP 814. It should be appreciated that the radio receiver may include multiple signal paths, each of which may include a transformer 806, an LNA 808, a filter 810, and an ADC 812.

Memory 816 stores instructions that, when executed by MCU 815, cause MCU 815 to perform various operations. For example, memory 816 stores signals strength/quality detection instructions 818, that when executed by MCU 815, cause MCU 815 to determine a parameter of the signal received from one of the multiple directional antennas, such as a signal strength, an SNR parameter, or another parameter. Memory 816 further includes AM signal mode logic instructions 824 that, when executed by MCU 815, cause MCU 815 to select an appropriate AM signal mode, such as a directional diversity mode or an algebraic received signal combination mode. When the directional diversity mode is selected, MCU 815 executes antenna/AM signal selection logic instructions 820 to control switching device 804 to select an appropriate one of antenna signals received from the multiple directional antennas 802, for example, based on the relative signal strengths, SNR parameters, or another parameter determined using signal strength/quality detection instructions 818. In an embodiment having multiple signal paths and omitting switching device 804, signals from each of the multiple directional antennas 802 may be provided via separate signal paths to DSP 814, and MCU 815 may then instruct the DSP 814 to select between the signals to provide directional diversity.

In the algebraic received-signal combination mode, DSP 814 executes AM signal add/subtract logic instructions 822, causing DSP 814 to algebraically combine the antenna signals. In a particular example, switching device 804 can be omitted, and multiple transformers 806, LNAs 808, filters 810, and ADCs 812 can provide separate signal paths from the multiple directional antennas 802 to DSP 814, allowing DSP 814 to perform the directional diversity and/or combination operations directly to the received signals. Alternatively, multiple switching devices 804 can be utilized to provide multi-signal switching and combinational functionality by switching the signals through different signal paths.

FIG. 9 is a schematic diagram of one possible embodiment of a switching circuit 900, which can serve as multiplexer 616, to switch between directional antennas, such as air-core loop antenna 104 and loop stick antenna 114 of the external accessory 304 of FIG. 3. Switching circuit 900 includes a first loop enable input terminal 902, a second loop enable input terminal 904, a first output terminal 906, and a second output terminal 908. Switching circuit 900 further includes a first antenna input terminal 910 and a second antenna input terminal 912 configurable to connect to a first loop antenna, such as air-core loop antenna 104. Switching circuit 900 also includes a third antenna input terminal 914 and a fourth antenna input terminal 916 configurable to connect to a second loop antenna, such as loop stick antenna 114.

Switching circuit 900 includes a first transistor 918 having a drain connected to first antenna terminal 910, a gate connected to first loop enable input terminal 902, and a source connected to first output terminal 906. Switching circuit 900 further includes a second transistor 920 having a drain connected to second antenna terminal 910, a gate connected to first loop enable input terminal 902, and a source connected to second output terminal 908. Switching circuit 900 also includes a third transistor 922 and a fourth transistor 924. Third transistor 922 includes a drain connected to third antenna terminal 914, a gate connected to second loop enable input terminal 904, and a source connected to first output terminal 906. Fourth transistor 924 includes a drain connected fourth antenna terminal 916, a gate connected to second loop enable input terminal 904, and a source connected to second output terminal 908.

In operation, a positive voltage applied to first loop enable input terminal 902 connects a first antenna at first and second antenna terminals 910 and 912 to first and second outputs 906 and 908, which are connected to a transformer circuit. Alternatively, application of a positive voltage signal to second loop enable input terminal 904 connects an antenna at third and fourth antenna terminals 914 and 916 to first and second outputs 906 and 908.

In a particular embodiment, transistors 918, 920, 922, and 924 are N-channel metal oxide semiconductor field effect transistors (MOSFETS) with relatively low on-resistances of approximately one ohm. Further, transistors 918, 920, 922, and 924 may also have relatively low parasitic capacitances.

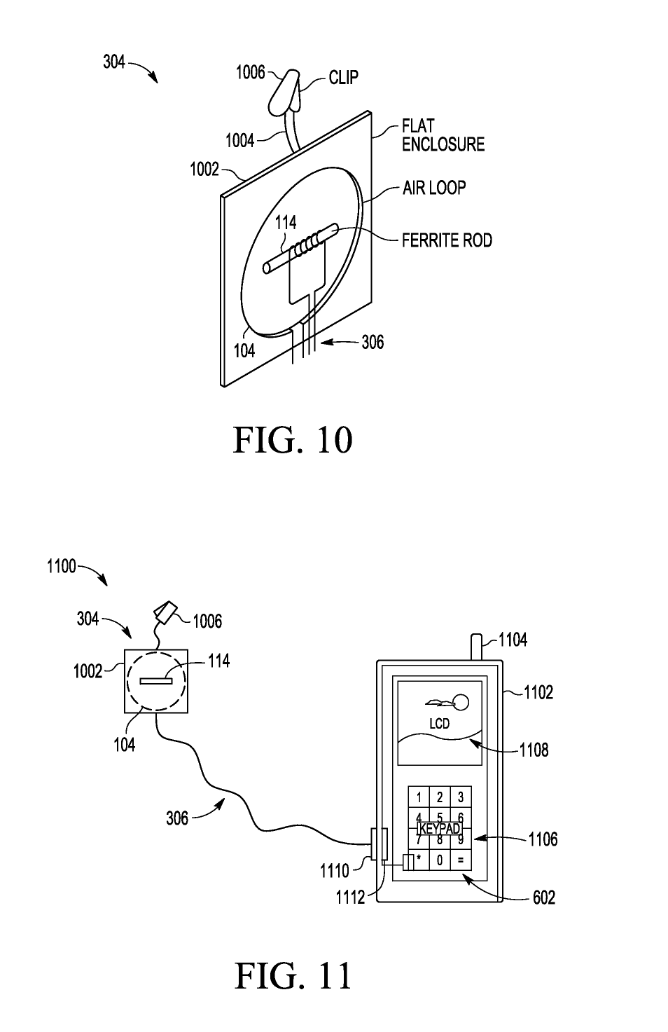

FIG. 10 is a diagram of an embodiment of an external accessory 304 having multiple directional antennas with substantially complementary reception patterns. External accessory 304 includes an enclosure 1002 connected to a first end of a wire 1004, which has a second end connected to a clip 1006. Clip 1006 is configurable to connect to something, such as a user's collar, shirt, or pocket or to a small profile structure such as a pin or a nail.

External accessory 304 includes air-core loop antenna 104 and loop stick antenna 114 connected to interconnect wires 306, which can be connected to a portable device, such as a cell phone (as illustrated in FIG. 11). Air-core loop antenna 104 and loop stick antenna 114 are arranged in a common plane, such that the external accessory 304 has a substantially flat form factor. In the illustrated example, the enclosure 1002 of external accessory 304 is substantially square having dimensions defined in part by the length and diameter of the ferrite core of loop stick antenna 114.

In a particular embodiment, loop stick antenna 114 has a ferrite core that is approximately 7 mm by 4 mm in cross-section and approximately 40 mm or more in length. In this instance, approximately 15 turns of Litz wire (a type of wire that carries high frequency AC signals) yields an inductance of approximately 16 μH. Air-core loop antenna 104 has a diameter of approximately 40 mm or greater. A 40 mm diameter loop with 15 turns of 30 gauge wire-wrap wire yields an inductance of approximately 16 μH and a suitable Q factor, such as a Q factor of 30 or better. The wire's insulation puts the conductor pitch at about twice the conductor diameter, which enhances the Q factor. A larger wire can be used for a higher Q factor. In a particular embodiment, air-core loop antenna 104 can be manufactured from a loop of flex-circuit printed wiring board (PWB) or ribbon cable.

In the illustrated embodiment, enclosure 1002 has dimensions of approximately 40 mm×40 mm and a depth that is defined by the thickness of the ferrite rod within loop stick antenna 114. However, other sizes and shapes of enclosure 1002 can also be used, such as a substantially circular enclosure, a rectangular enclosure, or other shapes. Further, while for an air-core loop antenna 104 with a diameter of 40 mm and ferrite stick having a length of 40 mm, enclosure 1002 can be slightly larger than 40 mm to fully encase both antennas.

FIG. 11 is a diagram of a system 1100 including a cell phone 1102 coupled to the external accessory 304 of FIGS. 3 and 10. External accessory 304 includes air-core loop antenna 104 and loop stick antenna 114 connected by interconnect wires 306 to a connector 1110, which connects to an interface 1112 of cell phone 1102. Cell phone 1102 includes an antenna 1104, a keypad interface 1106, and a display 1108. Cell phone 1102 houses a circuit configured to select between air-core loop antenna 104 and loop stick antenna 114, such as radio receiver circuit 602. Depending on the implementation, multiplexer 308 in FIG. 3, multiplexer 616, switching device 804, or switching circuit 900 can be included within connector 1110, within enclosure 1002, or within cell phone 1102.

While system 1100 depicts external accessory 304 as being connected to a cell phone 1102, it should be appreciated that external accessory 304 can be configured to connect to various AM signal processing devices, such as portable computers, portable media players, or any portable electronic device configurable to process medium wave radio frequency signals.

Further, while the above-discussion of FIGS. 3-11 addressed AM signals specifically, the apparatus can be used for reception any RF signals having audio or data content at frequencies below approximately 60 MHz, including short-wave and medium-wave RF signals. Such signals can include AM radio signals and Digital Radio Mondiale (DRM) RF signals as well as other types of RF signals.

In conjunction with the systems and methods described above with respect to FIGS. 3 and 6-11, an apparatus is disclosed that includes an antenna accessory having multiple directional antennas arranged to provide complementary signal reception patterns and that includes circuitry connected to the antenna accessory. The circuitry is configured to select between antennas to provide directional diversity for AM signal reception. In one embodiment, the antenna accessory is implemented as a wearable component within a housing that can be clipped to a user's clothing and connected to a cell phone, or other electronic device, to deliver AM signals to the cell phone. Further, a processor, such as a DSP, within the cell phone can be programmed with instructions (firmware) for selectively choosing one of the multiple directional antennas for receiving the AM signal based on a parameter of the signal, such as signal strength, SNR, or some other parameter.

Although the present invention has been described with reference to preferred embodiments, workers skilled in the art will recognize that changes may be made in form and detail without departing from the scope of the invention.

What is claimed is:

1. A radio receiver comprising:
a first terminal for receiving a radio frequency (RF) input signal including content at frequencies below approximately 60 MHz;
a second terminal for providing a multiplex signal;
a receive path having an input coupled to the first terminal, and an output for providing a demodulated RF signal corresponding to the radio signal;
a detector coupled to the receive path for detecting a signal parameter in the RF input signal that corresponds to the radio signal; and
a controller coupled to the detector and to the second terminal, the controller configured to provide the multiplex signal in a tuning state to selectively provide one of a first RF signal from a first directional antenna and a second RF signal from a second directional antenna to the first terminal as the RF input signal and to determine at least one of a first signal parameter of the first RF signal and a second signal parameter of the second RF signal in response to providing the multiplex signal, and provide the multiplex signal in an operating state based on the first signal parameter and the second signal parameter.

2. The radio receiver of claim 1, wherein the first signal parameter and the second signal parameter comprise power levels.

3. The radio receiver of claim 1, wherein the first signal parameter and the second signal parameter comprise signal-to-noise ratios.

4. The radio receiver of claim 1, wherein the first signal parameter and the second signal parameter comprise signal strengths.

5. The radio receiver of claim 1, wherein the first terminal and the second terminal comprise terminals of an integrated circuit.

6. The radio receiver of claim 1, wherein the receive signal path comprises:
a front-end circuit including an input for receiving the RF input signal, and an output for providing a converted signal; and
a digital signal processor including an input coupled to the output of the front-end circuit, the digital signal processor to execute a first plurality of instructions stored in a memory to provide a demodulated RF signal.

7. The radio receiver of claim 6, wherein the detector operates using the digital signal processor and a second plurality of instructions stored in the memory.

8. The radio receiver of claim 7, wherein the controller operates using the digital signal processor and a third plurality of instructions stored in the memory.

9. A radio receiver comprises:
a receive path having an input terminal for receiving a low-frequency radio frequency (RF) signal including at least one of a first RF signal and a second RF signal, and an output for providing a demodulated RF signal, the low-frequency RF signal having at least one of audio or data content at frequencies below approximately 60 MHz;
a detector coupled to the receive path for detecting a signal parameter in the low-frequency RF input signal that corresponds to the at least one of the first and second RF signals; and
a controller configured to dynamically select between the first RF signal and the second RF signal in response to detecting the signal parameter.

10. The radio receiver of claim 9, wherein the low-frequency RF signal comprises at least one of a medium wave RF signal and a short wave RF signal.

11. The radio receiver of claim 9, wherein the low-frequency RF signal comprises at least one of an Amplitude Modulated (AM) RF signal and a Digital Radio Mondiale (DRM) signal.

12. The radio receiver of claim 9, wherein the signal parameter comprises at least one of a signal strength, a power level, and a signal-to-noise ratio.

13. The radio receiver of claim 9, wherein the input terminal comprises a first terminal of an integrated circuit, the integrated circuit comprising:
a second terminal coupled to the controller, the second terminal for providing a selection signal from the controller.

14. The radio receiver of claim 13, further comprising a multiplexer comprising:
a first input terminal for receiving the first RF signal;
a second input terminal for receiving the second RF signal;
a multiplexer output terminal coupled to the input terminal;
a control input terminal coupled to the second terminal of the integrated circuit; and
wherein the multiplexer is configured to selectively provide one of the first RF signal and the second RF signal to the multiplexer output in response to the selection signal.

15. The radio receiver of claim 9, further comprising isolation circuitry including an isolation input terminal configurable to receive a first RF input signal and including an isolation output terminal for providing the RF input signal to the input terminal.

16. The radio receiver of claim 15, wherein the isolation circuitry includes a transformer circuit comprising:
a primary winding coupled to the isolation input terminal and having a first number of turns of wire;
a secondary winding coupled to the isolation output terminal and having a second number of turns of wire; and
wherein the second number is greater than the first number.

17. The radio receiver of claim 9, wherein the input terminal is coupled to an input/output port adapted to receive a connector associated with an external antenna device comprising:
a first directional antenna having a first signal reception pattern, the first directional antenna to provide the first RF signal;
a second directional antenna having a second signal reception pattern that is substantially orthogonal to the first signal reception pattern, the second directional antenna to provide the second RF signal; and
the connector coupled to the first directional antenna and the second directional antenna and adapted to deliver radio frequency (RF) signals to the input terminal.

18. The radio receiver of claim 9, wherein the detector detects the signal parameters in response to at least one of a user selection switching between a frequency modulated (FM) radio band and an AM radio band, a timing signal having a pre-defined period, and a user selection of a radio station frequency.

19. A radio receiver comprises:
a casing defining an enclosure;
a first directional antenna within the enclosure having a first signal reception pattern;
a second directional antenna within the enclosure and having second signal reception pattern that substantially complements the first signal reception pattern; and
a connector coupled to the first and second directional antennas and adapted to deliver radio frequency signals to an input of a portable electronic device.

20. The radio receiver of claim 19, further comprising a clip coupled to the casing and configured to releasably attach the casing to an object.

21. The radio receiver of claim 19, further comprising a multiplexer responsive to a control signal from the portable electronic device to select between the first directional antenna and the second directional antenna.

22. The radio receiver of claim 19, wherein the first directional antenna and the second directional antenna comprise loop antennas configured to receive short wave and medium wave radio frequency signals.

23. The radio receiver of claim 19, wherein the portable electronic device comprises one of a cell phone and a portable media player including a radio frequency receiver.

24. A system comprising:
an antenna assembly for receiving a radio frequency (RF) signal, including at least one of a short wave signal and a medium wave signal, having at least one of audio and data content at frequencies below approximately 60 MHz, the antenna assembly comprising:
a first directional antenna having a first signal reception pattern;
a second directional antenna defining a second signal reception pattern that is substantially complementary relative to the first signal reception pattern; and
a connector coupled to the first directional antenna and the second directional antenna; and
a radio receiver comprising:
an input port adapted to couple to the connector;
a receive path including an input terminal coupled to the input port and adapted to receive the RF signal from at least one of the first directional antenna and the second directional antenna, and an output terminal for providing a demodulated RF signal;
a detector coupled to the receive path for detecting a signal parameter in the RF input signal that corresponds to the AM signal; and
a controller configured to dynamically select between the first directional antenna and the second directional antenna in response to detecting the signal parameter.

25. The system of claim 24, wherein the first directional antenna and the second directional antenna are substantially coplanar.

26. The system of claim 24, wherein the first signal reception pattern and the second signal reception pattern are substantially orthogonal to one another.

27. The system of claim 24, wherein the antenna assembly comprises an external accessory including a housing and a clip configurable to secure the housing to an article of clothing.

28. The system of claim 24, wherein the radio receiver comprises an integrated circuit within a portable electronic device.
